(19) United States
(12) Patent Application Publication
(10) Pub. No.: US 2010/0296579 A1
(43) Pub. Date: Nov. 25, 2010

(54) ADAPTIVE PICTURE TYPE DECISION FOR VIDEO CODING

(75) Inventors: RAHUL P. PANCHAL, San Diego, CA (US); MARTA KARCZEWICZ, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/782,993

(22) Filed: May 19, 2010

Related U.S. Application Data
(60) Provisional application No. 61/180,793, filed on May 22, 2009.

(51) Int. Cl. H04N 7/32

(52) U.S. Cl. 375/240.15; 375/E07.243

(57) ABSTRACT

A video encoding apparatus determines whether to encode a key frame of a group of pictures using a bi-directional prediction mode. In one example, a video encoding apparatus includes a mode select unit configured to generate a virtual key frame for a current group of pictures based on a previous key frame of a previous group of pictures and a next key frame of a next group of pictures, calculate an error value representing error between a current key frame of the current group of pictures and the virtual key frame, and determine whether the error value exceeds a threshold value, and a video encoder configured to encode the current key frame using a bi-directional prediction encoding mode when the error value does not exceed the threshold value. The video encoder may comprise the mode select unit, or a preprocessing unit of the apparatus may comprise the mode select unit.

This application claims the benefit of U.S. Provisional Application No. 61/180,793, filed May 22, 2009, which is hereby incorporated by reference in its entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

### SUMMARY

In general, this disclosure describes techniques for adaptively determining an encoding mode for key frames of a group of pictures. A group of pictures (GOP) generally includes a plurality of frames or pictures, the last of which is typically referred to as a “key frame” or “key picture.” Typically, the key frame is encoded using either intra-mode encoding or inter-mode encoding with reference to a single reference frame as a P-frame. The techniques of this disclosure include determining whether to encode a key frame otherwise designated to be encoded as a P-frame instead as a B-frame, i.e., with reference to two reference frames. The decision to encode the key frame as a B-frame instead of as P-frame may occur when the key frame coincides with a scene change, a cross fade, video morphing, or other instances in which a key frame occurs between two frames with divergent data for which encoding as a B-frame may result in reduced error.

In one example, a method includes generating a virtual key frame for a current group of pictures based on a previous key frame of a previous group of pictures and a next key frame of a next group of pictures, calculating an error value representing error between a current key frame of the current group of pictures and the virtual key frame, determining whether the error value exceeds a threshold value, and when the error value does not exceed the threshold value, encoding, with a video encoder, the current key frame using a bi-directional prediction encoding mode.

In another example, an apparatus includes a mode select unit configured to generate a virtual key frame for a current group of pictures based on a previous key frame of a previous group of pictures and a next key frame of a next group of pictures, calculate an error value representing error between a current key frame of the current group of pictures and the virtual key frame, and determine whether the error value exceeds a threshold value, and a video encoder configured to encode the current key frame using a bi-directional prediction encoding mode when the error value does not exceed the threshold value.

In another example, an apparatus includes means for generating a virtual key frame for a current group of pictures based on a previous key frame of a previous group of pictures and a next key frame of a next group of pictures, means for calculating an error value representing error between a current key frame of the current group of pictures and the virtual key frame, means for determining whether the error value exceeds a threshold value, and means for encoding the current key frame using a bi-directional prediction encoding mode when the error value does not exceed the threshold value.

In another example, a computer-readable medium, such as a computer-readable storage medium, contains, e.g., is encoded with, instructions that cause a programmable processor to generate a virtual key frame, in place of a current key frame of a current group of pictures, from a previous key frame of a previous group of pictures and a next key frame of a next group of pictures, calculate an error value representing error between the current key frame and the virtual key frame, determine whether the error value exceeds a threshold value, and encode the current key frame using a bi-directional prediction encoding mode when the error value does not exceed the threshold value.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for encoding a key frame using a B-encoding mode rather than a P-encoding mode in accordance with the techniques of this disclosure.

FIG. 2 is a block diagram illustrating an example of a video encoder that may implement techniques for determining whether to encode a key frame using a bi-directional prediction encoding mode consistent with this disclosure.

FIG. 3 is a block diagram illustrating an example of a video decoder, which decodes an encoded video sequence.

FIG. 4 is a conceptual diagram illustrating two example groups of pictures and corresponding key frames.

FIG. 5 is a flowchart illustrating an example method for determining whether to B-mode inter-prediction encode a key frame that is otherwise designated for P-mode inter-prediction encoding.

FIG. 6 is a block diagram illustrating an example of a video source device that includes a video preprocessor comprising a mode select unit.

### DETAILED DESCRIPTION

The techniques of this disclosure relate to encoding a key frame of a group of pictures (GOP) as a B-frame, instead of a P-frame. In particular, a key frame designated for encoding as a P-frame may instead be encoded using a bi-directional prediction mode, that is, as a B-frame. The techniques described in this disclosure include determining whether a key frame designated to be encoded as a P-frame should instead be encoded as a B-frame. In general, a video encoder or other video encoding apparatus implementing these methods may determine that key frames designated to be encoded as P-frames should instead be encoded as B-frames, e.g., when the key frames coincide with a scene change, a cross fade, video morphing, or other situations in which bi-directional predictive encoding from two reference frames may result in reduced error, relative to uni-directional predictive encoding. In this manner, the techniques of this disclosure may achieve adaptive picture type decisions, e.g., for a key frame of a group of pictures. In general, P-encoding comprises uni-directional predictive encoding, while B-encoding comprises bi-directional predictive encoding. In some examples, P-encoded frames may refer to multiple reference frames, but in only one direction, while B-encoded frames may refer to multiple reference frames in each direction.

In one example, a method includes generating a virtual key frame, in place of a current key frame of a current group of pictures, from a previous key frame of a previous group of pictures and a next key frame of a next group of pictures, calculating an error value representing error between the current key frame and the virtual key frame, determining whether the error value exceeds a threshold value, and, when the error value does not exceed the threshold value, encoding, with a video encoder, the current key frame using a bi-directional prediction encoding mode. Examples of how various steps of this method may be performed are described in greater detail below.

The process of generating a virtual key frame may include interpolating the virtual key frame from one or more frames surrounding a current key frame, for which the decision as to whether to encode the key frame as a B-frame is being made. As noted in the example method above, the surrounding frames may comprise key frames of the immediately preceding GOP and the immediately subsequent GOP, generally referred to as a previous key frame and a next key frame. A GOP generally comprises a plurality of frames, including a key frame that is either to be intra-mode encoded or inter-mode uni-directionally encoded. Key frames are generally located at the same position within each GOP of a bitstream, e.g., as the last temporally displayed frame in each GOP. In some examples, the method further includes calculating a weight value to apply to each of the previous key frame and the next key frame. The weight value may comprise a percentage value, such that the weight value is applied to the previous key frame and a supplementary weight value, that is, the remaining percentage to accumulate a full one hundred percent, may be applied to the next key frame.

Calculation of an error value may be performed according to any error calculation scheme. Examples include sum of absolute difference (SAD), sum of squared difference (SSD), mean absolute difference (MAD), and mean squared difference (MSD), although other error calculation functions can be performed. In general, an error between the virtual key frame and the current key frame may be calculated and compared to a threshold value. The error calculation is performed in the pixel domain, and need not be performed using any motion vector data. The comparison between the current key frame and the virtual key frame indicates whether the virtual key frame, interpolated from two other key frames, is sufficiently similar to the current key frame that encoding the current key frame as a B-frame would reduce error resulting from encoding of the current key frame otherwise. The threshold value may comprise a fixed value, or may correspond to another error metric. For example, the threshold may comprise the lower of the error between the current key frame and the previous key frame and the error between the current key frame and the next key frame. Other threshold values may also be used that are fixed, variable, configurable, and/or mathematically related to other metrics.

When the error between the current key frame and the virtual key frame is determined to be lower than the threshold value, the current key frame may be encoded as a B-frame. That is, if the error is less than the threshold value, a video encoder may encode the current key frame using a bi-directional prediction encoding mode. In some examples, the error value may be modified using a bias value, to influence the decision as to whether to encode the key frame as a B-frame in one direction or the other. Although the video encoder may treat the key frame as a B-frame, the video encoder may encode each block, macroblock, or other coded unit of the video frame using intra-prediction encoding or using uni-directional or bi-directional inter-prediction encoding. That is, the mode selection process for each block of the current key frame does not necessarily mirror the selected encoding mode for the current key frame. Typically, when the key frame is encoded as a B-frame, the two reference frames for the B-frame comprise the previous key frame of a previous GOP and the next key frame of the next GOP, where the current key frame is part of a current GOP intermediate to the previous GOP and the next GOP. On the other hand, when the error value produced for the virtual key frame (as influenced by the bias value, in some examples) is determined to equal or exceed the threshold, the video encoder may instead encode the current key frame as the current key frame would have otherwise been encoded, e.g., as a P-frame or an I-frame. When the current key frame is encoded as an I-frame, each block of the current key frame may also be encoded using intra-prediction, although additional mode selection processes, e.g., to partition each block and separately encode each partition, may also be performed.

Video compression standards such as ITU-T H.261, H.263, MPEG-1, MPEG-2 and H.264/MPEG-4 part 10 make use of motion compensated temporal prediction to reduce temporal redundancy. The encoder uses a motion compensated prediction from some previously encoded pictures (also referred to herein as frames) to predict the current coded pictures according to motion vectors. There are three major picture types in typical video coding. They are Intra coded picture (“I-pictures” or “I-frames”), Predicted pictures (“P-pictures” or “P-frames”) and Bi-directional predicted pictures (“B-pictures” or “B-frames”). P-pictures use only the reference picture before the current picture in temporal order. In a B-picture, each block of the B-picture may be predicted from one or two reference pictures. These reference pictures could be located before or after the current picture in temporal order.

In accordance with the H.264 coding standard, as an example, B-pictures use two lists of previously-coded reference pictures, list 0 and list 1. These two lists can each contain past and/or future coded pictures in temporal order. Blocks in a B-picture may be predicted in one of several ways: motion-compensated prediction from a list 0 reference picture, motion-compensated prediction from a list 1 reference picture, or motion-compensated prediction from the combination of both list 0 and list 1 reference pictures. To get the combination of both list 0 and list 1 reference pictures, two motion compensated reference areas are obtained from list 0 and list 1 reference picture respectively. Their combination will be used to predict the current block.

The term macroblock refers to a data structure for encoding picture and/or video data according to a two-dimensional pixel array that comprises 16×16 pixels. Each pixel comprises a chrominance component and a luminance component. Accordingly, the macroblock may define four luminance blocks, each comprising a two-dimensional array of 8×8 pixels, two chrominance blocks, each comprising a two-dimensional array of 16×16 pixels, and a header comprising syntax information, such as a coded block pattern (CBP), an encoding mode (e.g., intra-(I), or inter-(P or B) encoding modes), a partition size for partitions of an intra-encoded block (e.g., 16×16, 16×8, 8×16, 8×8, 8×4, 4×8, or 4×4), or one or more motion vectors for an inter-encoded macroblock.

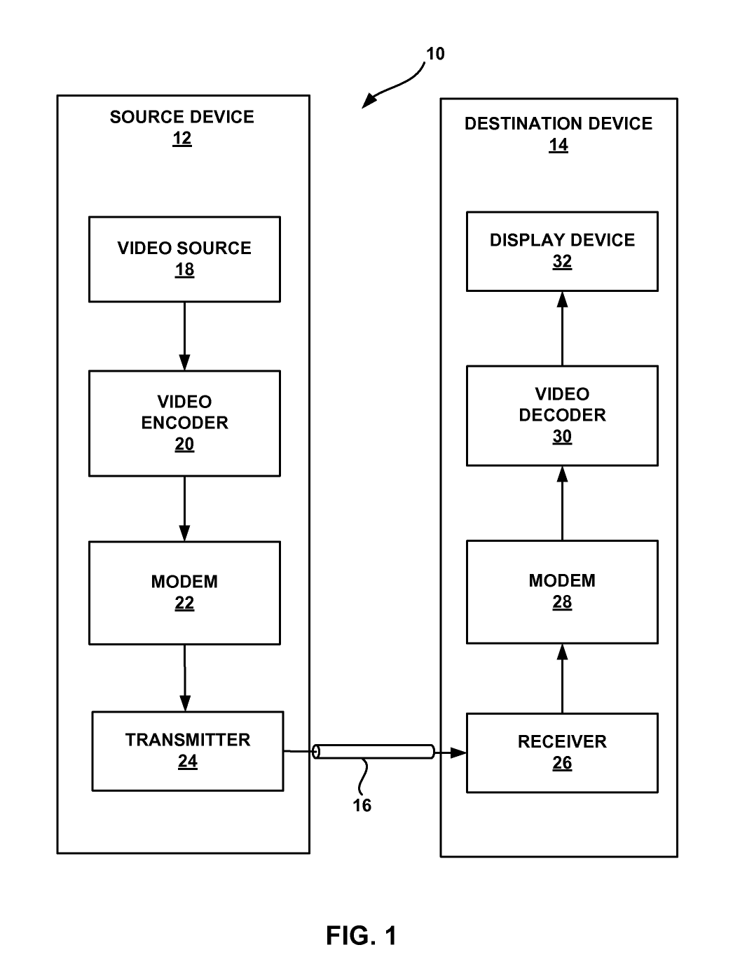

FIG. 1 is a block diagram illustrating an example video encoding and decoding system 10 that may utilize techniques for encoding a key frame using a B-encoding mode rather than a P-encoding mode in accordance with the techniques of this disclosure. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless. The techniques of this disclosure, however, which concern determining whether to encode a key frame, designated for encoding using a P-encoding mode, instead using a B-encoding mode, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 may be configured to apply the techniques for determining whether to encode a key frame, designated to be encoded using a P-mode, instead using a B-mode. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for encoding a key frame using a B-encoding mode as described in this disclosure may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, an/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process may implement one or more of the techniques described herein to determine whether to encode a key frame of a group of pictures that is designated to be encoded in a P-encoding mode instead in a B-encoding mode prior to encoding the video data. The information communicated over channel 16 may include syntax information defined by video encoder 20, which is also used by video decoder 30, that includes syntax elements that describe characteristics and/or processing of macroblocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the ITU-T H.264 standard, alternatively described as MPEG-4, Part 10, Advanced Video Coding (AVC). The techniques of this disclosure, however, are not limited to any particular coding standard. Other examples include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames, ending with a key frame. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks within individual video frames in order to encode the video data. A video block may correspond to a macroblock or a partition of a macroblock. The video blocks may have fixed or varying sizes, and may differ in size according to a specified coding standard. Each video frame may include a plurality of slices. Each slice may include a plurality of macroblocks, which may be arranged into partitions, also referred to as sub-blocks.

As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “×” and “by” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns.

Block sizes that are less than 16 by 16 may be referred to as partitions of a 16 by 16 macroblock. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to the residual video block data representing pixel differences between coded video blocks and predictive video blocks. In some cases, a video block may comprise blocks of quantized transform coefficients in the transform domain.

Smaller video blocks can provide better resolution, and may be used for locations of a video frame that include high levels of detail. In general, macroblocks and the various partitions, sometimes referred to as sub-blocks, may be considered video blocks. In addition, a slice may be considered to be a plurality of video blocks, such as macroblocks and/or sub-blocks. Each slice may be an independently decodable unit of a video frame. Alternatively, frames themselves may be decodable units, or other portions of a frame may be defined as decodable units. The term “coded unit” or “coding unit” may refer to any independently decodable unit of a video frame such as an entire frame, a slice of a frame, a group of pictures (GOP) also referred to as a sequence, or another independently decodable unit defined according to applicable coding techniques.

In accordance with the techniques of this disclosure, video encoder 20 may determine whether a key frame, which was originally determined to be inter-prediction coded using P-mode inter-prediction encoding, should instead be inter-prediction coded using B-mode inter-prediction encoding. In general, key frames are either intra-prediction encoded or inter-prediction encoded in P-mode. Video encoder 20 may intra-encode key frames that are designated for intra-prediction encoding, but may use the techniques of this disclosure to determine, for those key frames designated for P-mode inter-prediction encoding, whether to instead encode each of those frames using B-mode inter-prediction encoding.

In general, the techniques for making this determination involve examining the two key frames adjacent to the “current” key frame for which the determination is being made. That is, for a current key frame of a current GOP, video encoder 20 determines whether to inter-prediction encode the current key frame using a B-mode, rather than inter-prediction encoding the current key frame using a P-mode, by analyzing the key frame of the GOP immediately before the current GOP and the key frame of the GOP immediately after the current GOP. The ordering of the GOPs described herein may conform to the temporal display ordering of the frames of the GOPs. That is, frames of the previous GOP are intended to be displayed before frames of the current GOP, and frames of the current GOP are intended to be displayed before frames of the next GOP.

The analysis for the determination generally involves constructing a virtual key frame according to pixel data of the key frame of the previous GOP and pixel data of the key frame of the next GOP, relative to the current GOP. That is, the analysis does not necessarily require access to motion vector data or other video data. Rather, the analysis can be performed used pixel domain data for the key frames. Accordingly, the techniques of this disclosure may be performed by a video encoder, such as video encoder 20, but alternatively may be performed by a video preprocessing unit or other unit external to video encoder 20 that receives raw video frame pixel data prior to video encoder 20. Such a video preprocessing unit may comprise, for example, a microprocessor, an application specific integrated circuit (ASIC), a digital signal processor (DSP), a field programmable logic array (FPGA), or other control unit. In some examples, a single processor may be configured to perform the determination for the key frames as a first subroutine and to encode the video data according to the determination as a second subroutine. In some examples, a preprocessing unit may compute a virtual key frame, and video encoder 20 may be configured to compute error values using the virtual key frame and determine whether the error values computed using the virtual key frame indicate that the current key frame should be B-mode inter-prediction encoded.

In some examples, encoding modes for frames of a GOP are determined before encoding of the GOP begins. For example, video encoder 20 may be configured to use a pattern such as “B-B-B-P-B-B-B-P-B-B-B-P” or “B-B-B-P-B-B-B-P-B-B-B-I” for each GOP, where each GOP includes 12 frames of video data. In these two example patterns, the key frame occurs at the end of the GOP, and as such the key frame is either encoded as a P-frame or an I-frame. Video encoding standards may dictate that an I-frame must occur every X number of frames. In some examples, video encoder 20 may apply the techniques of this disclosure to determine whether to B-encode a key frame that is otherwise designated for intra-mode encoding (that is, an I-frame), so long as the determination does not result in a violation of the applicable video coding standard. For example, assuming that the standard requires that an I-frame occurs every 90 frames, and the current key frame is the ninetieth frame in a continuous sequence of inter-encoded frames, the video encoder may encode the key frame as an I-frame even when the techniques of this disclosure would otherwise prescribe encoding the key frame using a B-encoding mode.

The determination of whether to inter-prediction encode the current key frame using a B-mode, rather than to inter-prediction encode the current key frame using a P-mode, generally involves interpolating a virtual key frame as a temporary substitute for the key frame of the current GOP using the key frame of the previous GOP (the “previous key frame”) and the key frame of the next GOP (the “next key frame”). The determination includes determining a weighting value to apply to the pixel values of the previous key frame and to the next key frame. The weighting value w may comprise a percentage contribution value, whereby the value of a pixel in the virtual key frame is determined as respective percentages of collocated pixels in the previous key frame and the next key frame. For example, if the weighting value is 0.3, the pixel value of the virtual key frame may comprise a value equal to 0.3 times the value of the pixel in the collocated position of the previous key frame plus 0.7 (that is, the remaining percentage, determined in this example case by “1−0.3”) times the value of the pixel in the collocated position of the next key frame.

After having generated the virtual key frame, video encoder 20 may calculate error values from the virtual key frame, the current key frame, the previous key frame, and the next key frame, and evaluate the error values to finalize the determination of whether to inter-prediction encode the current key frame using a B-mode. Video encoder 20 may calculate the error values using any error metric, e.g., sum of absolute difference (SAD), sum of squared difference (SSD), mean absolute difference (MAD), mean squared difference (MSD), or other such error metrics. The virtual key frame, in accordance with the techniques of this disclosure, is used as an analysis tool prior to encoding the current key frame according to a coding mode decision from which to measure error values. In general, the virtual key frame may be discarded after having determined the error values and making the coding mode decision. That is, the virtual key frame is not necessary after the coding mode decision is made, because video encoder 20 will apply the selected encoding mode during encoding of the current key frame itself, and not the virtual key frame.

In one example, the error calculation includes determining an error value between the virtual key frame and the current key frame, i.e., the key frame for the current GOP, an error value between the current key frame and the previous key frame, i.e., the key frame for the previous GOP, and an error value between the current key frame and the next key frame, i.e., the key frame the next GOP. Each of these error values may be determined using any of SAD, SSD, MAD, MSD, or other error calculations. When the difference (that is, the error value) between the virtual key frame and the current key frame is relatively small, video encoder 20 may elect to encode the current key frame using a bi-directional prediction mode. To determine whether the error between the current key frame and the virtual key frame is small enough, in one example, video encoder 20 compares the error value between the current key frame and the virtual key frame to the error value between the current key frame and the previous key frame and to the error value between the current key frame and the next key frame. In one example, video encoder 20 determines to B-mode encode the current key frame when the error value between the current key frame and the virtual key frame is lower than both the error value between the current key frame and the next key frame and the error value between the current key frame and the previous key frame. In some examples, video encoder 20 may additionally utilize a bias value to influence the decision either in favor of or against B-mode encoding of the current key frame. For example, video encoder 20 may multiply the error value by the bias value to produce a biased error value. That is, video encoder 20 may multiply the error value between the current key frame and the virtual key frame by the bias value and compare the product of this calculation to the error value between the current key frame and the previous key frame and to the error value between the current key frame and the next key frame.

In another example, video encoder 20 may be configured to compute the error between the virtual key frame and the current key frame as a single error value. The error may be calculated according to SAD, SSD, MAD, MSD, or another error calculation. Video encoder 20 may then compare this error value to a threshold error value. In some examples, video encoder 20 may adjust the threshold error value to influence the decision to B-encode the key frame.

Following intra-predictive or inter-predictive coding to produce predictive data and residual data, and following any transforms (such as the 4×4 or 8×8 integer transform used in H.264/AVC or a discrete cosine transform DCT) to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data may be performed, e.g., according to content adaptive variable length coding (CAVLC), context adaptive binary arithmetic coding (CABAC), or another entropy coding methodology. A processing unit configured for entropy coding, or another processing unit, may perform other processing functions, such as zero run length coding of quantized coefficients and/or generation of syntax information such as coded block pattern (CBP) values, macroblock type, coding mode, maximum macroblock size for a coded unit (such as a frame, slice, macroblock, or sequence), or the like.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame. Video decoder 30 may therefore comprise a standard video decoder and need not necessarily be specially configured to effect or utilize the techniques of this disclosure. When video encoder 20 encodes a key frame using B-mode inter-prediction, video encoder 20 may effectively group the current GOP comprising the current key frame with the next GOP, forming a merged GOP. The merged GOP may comprise only one key frame, in particular, the key frame of the “next” GOP that was merged with the current key frame, and thus the “next” key frame becomes the effective key frame for the merged GOP. For example, if the current GOP and the next GOP each comprise 12 frames, with the current key frame having index value 12 and the next key frame having index value 24, video encoder 20 may group each of the frames of the current GOP and the next GOP into a single, merged GOP, and the key frame of the merged GOP would have index value 24. The key frame having index value 12 would not be treated as a key frame, but would instead comprise a B-mode encoded frame. Video encoder 20 may send corresponding syntax information to video decoder 30, which may determine that the merged GOP comprises 24 frames with a single key frame occurring at index position 24, that is, as the last frame in the merged GOP.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

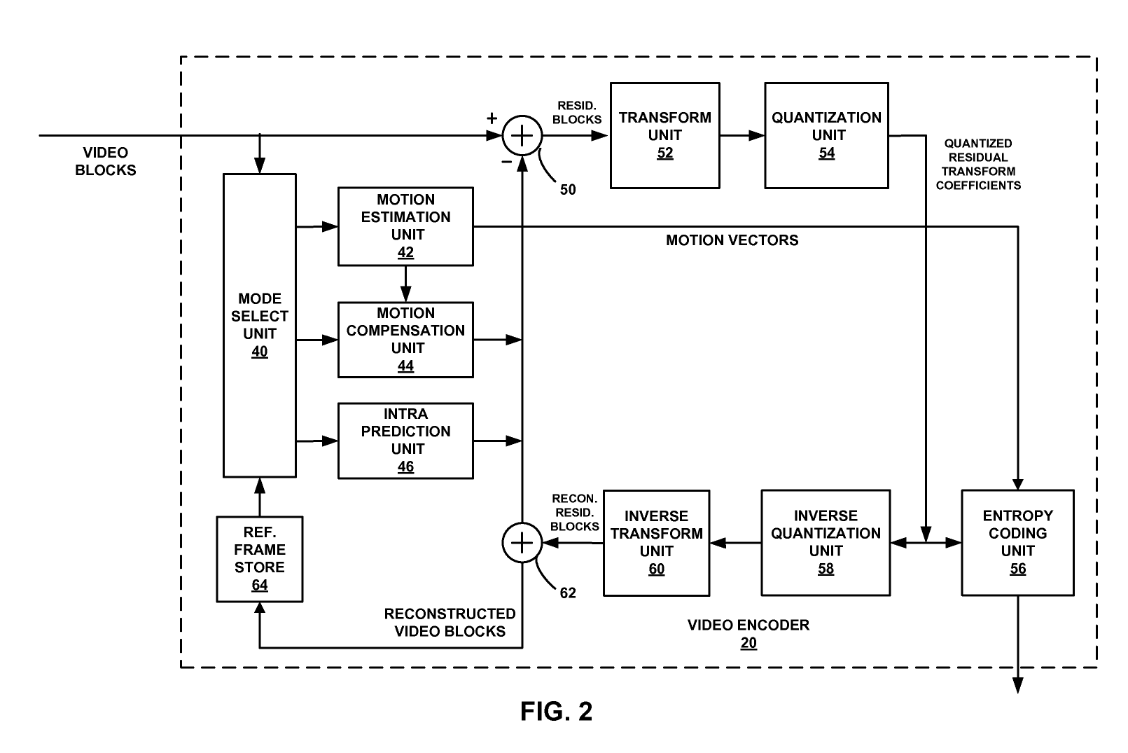

FIG. 2 is a block diagram illustrating an example of video encoder 20 that may implement techniques for determining whether to encode a key frame designated for a encoding using a P-mode instead using a B-mode consistent with this disclosure. Video encoder 20 may perform intra- and inter-coding of blocks within video frames, including macroblocks, or partitions or sub-partitions of macroblocks. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes and inter-modes such as uni-directional prediction (P-mode) or bi-directional prediction (B-mode) may refer to any of several temporal-based compression modes. Although components for inter-mode encoding are depicted in FIG. 2, it should be understood that video encoder 20 may further include components for intra-mode encoding. However, such components are not illustrated for the sake of brevity and clarity.

As shown in FIG. 2, video encoder 20 receives a current video block within a video frame to be encoded. In the example of FIG. 2, video encoder 20 includes motion compensation unit 44, motion estimation unit 42, reference frame store 64, summer 50, transform unit 52, quantization unit 54, and entropy coding unit 56. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. An intra prediction unit may also perform intra-predictive coding of the received video block relative to one or more neighboring blocks in the same frame or slice as the block to be coded to provide spatial compression.

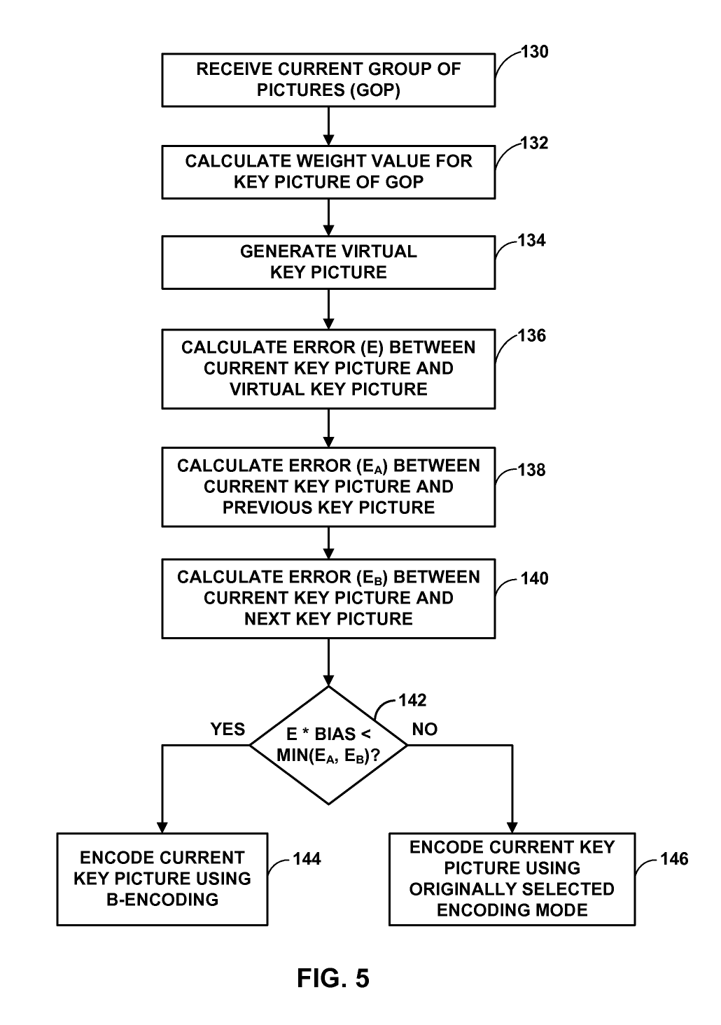

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 may also determine whether to encode a key frame that has otherwise been designated for P-mode encoding instead using B-mode encoding, consistent with the techniques of this disclosure. In some examples, mode select unit 40 may be configured to execute the techniques of this disclosure to make the determination as to whether to B-mode or P-mode encode a key frame when the key frame is to be inter-prediction mode encoded, e.g., as described in greater detail with respect to FIG. 5. In other examples, mode select unit 40 may be configured to recognize an indication from, e.g., a video preprocessing unit as to whether to P-mode or B-mode encode a key frame and select the corresponding encoding mode in accordance with the indication from the preprocessing unit. In still other examples, mode select unit 40 may be configured to recognize a mode selection from a preprocessing unit when such an indication exists, and when no such indication exists, to determine whether to encode a key frame using I-mode, P-mode, or B-mode. That is, mode select unit 40 may be configured to forego a mode decision process when mode select unit 40 receives an indication that a current key frame is to be encoded as a B-frame, e.g., from a video preprocessing unit.

Motion estimation unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. A motion vector may also indicate displacement of a partition of a macroblock. Motion compensation may involve fetching or generating the predictive block based on the motion vector determined by motion estimation. Again, motion estimation unit 42 and motion compensation unit 44 may be functionally integrated, in some examples.

Motion estimation unit 42 calculates a motion vector for the video block of an inter-coded frame by comparing the video block to video blocks of a reference frame in reference frame store 64. Motion compensation unit 44 may also interpolate sub-integer pixels of the reference frame, e.g., an I-frame or a P-frame. The ITU H.264 standard refers to reference frames as “lists.” Therefore, data stored in reference frame store 64 may also be considered lists. Motion estimation unit 42 compares blocks of one or more reference frames (or lists) from reference frame store 64 to a block to be encoded of a current frame, e.g., a P-frame or a B-frame. When the reference frames in reference frame store 64 include values for sub-integer pixels, a motion vector calculated by motion estimation unit 42 may refer to a sub-integer pixel location of a reference frame. Motion estimation unit 42 sends the calculated motion vector to entropy coding unit 56 and motion compensation unit 44. The reference frame block identified by a motion vector may be referred to as a predictive block. Motion compensation unit 44 calculates error values for the predictive block of the reference frame.

When mode select unit 40 determines to B-mode inter-prediction encode a key frame that was otherwise designated for P-mode encoding, mode select unit 40 signals motion estimation unit 42 and motion compensation unit 44 to encode the key frame using B-mode inter-encoding. Motion estimation unit 42 and motion compensation unit 44 may therefore first encode the next key frame, that is, the key frame of the GOP temporally following the current GOP. In this manner, a version of the next key frame after encoding and decoding will be stored in reference frame store 64. Likewise, a decoded version of the previous key frame will also be stored in reference frame store 64. Motion estimation unit 42 and motion compensation unit 44 may use the versions of the previous key frame and the next key frame stored in reference frame store 64 as the two reference frames used to B-mode inter-prediction encode the current key frame.

Motion compensation unit 44 may calculate prediction data based on the predictive block. Video encoder 20 forms a residual video block by subtracting the prediction data from motion compensation unit 44 from the original video block being coded. Summer 50 represents the component or components that perform this subtraction operation. Transform unit 52 applies a transform, such as a discrete cosine transform (DCT) or a conceptually similar transform, to the residual block, producing a video block comprising residual transform coefficient values. Transform unit 52 may perform other transforms, such as those defined by the H.264 standard, which are conceptually similar to DCT. Wavelet transforms, integer transforms, sub-band transforms or other types of transforms could also be used. In any case, transform unit 52 applies the transform to the residual block, producing a block of residual transform coefficients. The transform may convert the residual information from a pixel value domain to a transform domain, such as a frequency domain. Quantization unit 54 quantizes the residual transform coefficients to further reduce bit rate. The quantization process may reduce the bit depth associated with some or all of the coefficients. The degree of quantization may be modified by adjusting a quantization parameter.

Following quantization, entropy coding unit 56 entropy codes the quantized transform coefficients. For example, entropy coding unit 56 may perform content adaptive variable length coding (CAVLC), context adaptive binary arithmetic coding (CABAC), or another entropy coding technique. Following the entropy coding by entropy coding unit 56, the encoded video may be transmitted to another device or archived for later transmission or retrieval. In the case of context adaptive binary arithmetic coding, context may be based on neighboring macroblocks.

In some cases, entropy coding unit 56 or another unit of video encoder 20 may be configured to perform other coding functions, in addition to entropy coding. For example, entropy coding unit 56 may be configured to determine the CBP values for the macroblocks and partitions. Also, in some cases, entropy coding unit 56 may perform run length coding of the coefficients in a macroblock or partition thereof. In particular, entropy coding unit 56 may apply a zig-zag scan or other scan pattern to scan the transform coefficients in a macroblock or partition and encode runs of zeros for further compression. Entropy coding unit 56 also may construct header information with appropriate syntax elements for transmission in the encoded video bitstream.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame store 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame store 64. The reconstructed video block may be used by motion estimation unit 42 and motion compensation unit 44 as a reference block to inter-code a block in a subsequent video frame.

Video encoder 20 may also be configured to transmit syntax information for various coded units, e.g., blocks, macroblocks, slices, frames, and/or groups of pictures (GOPs). For example, when a key frame (in one example, the last frame of a GOP) is encoded using B-mode encoding rather than P-mode encoding, the GOP comprising the key frame and a temporally subsequent GOP are effectively merged to form a merged GOP. The syntax information for a GOP, transmitted in-band, e.g., in a header for the GOP or one or more frames of the GOP, may include a description of the number of frames in the GOP. The syntax information for the GOP may further describe a display order of the frames of the GOP and/or a decoding order for the frames of the GOP. Accordingly, video encoder 20 may be configured to set the syntax information for the GOP to describe which frames are included in the GOP. Because encoding a key frame using B-mode encoding typically changes the size of the GOP, this process may be considered adaptive formation of GOPs.

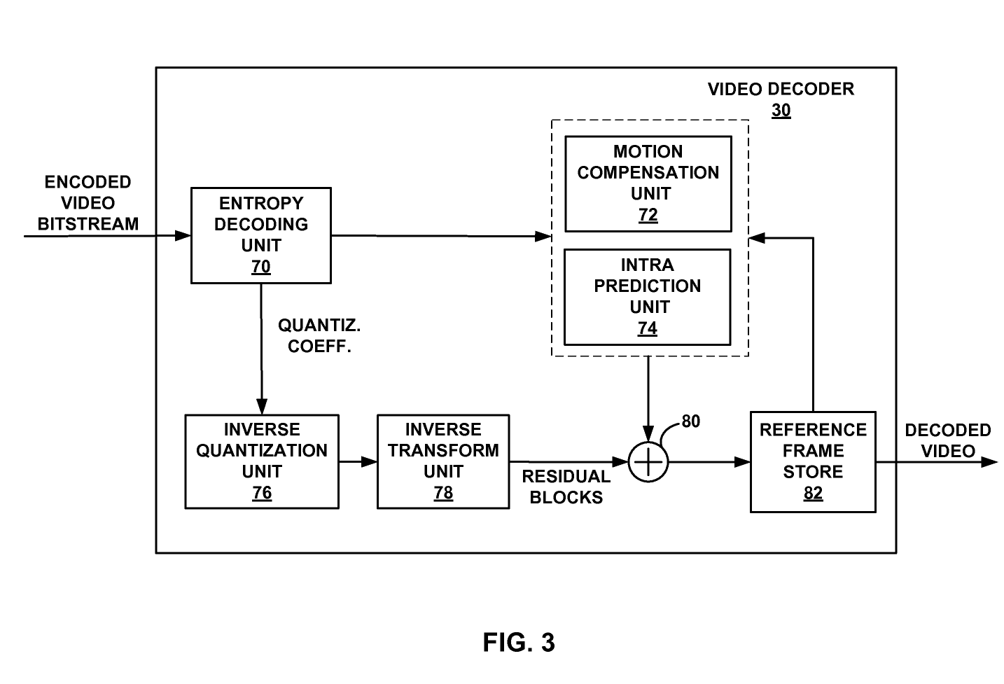

FIG. 3 is a block diagram illustrating an example of video decoder 30, which decodes an encoded video sequence. The encoded video sequence may include GOPs of various sizes. Each GOP may include one or more syntax elements that describe the number of frames in the GOP. In this manner, video decoder 30 may receive a merged GOP, comprising a B-encoded frame that was originally designated for encoding as a P-mode encoded key frame. However, because each GOP includes one key frame, the B-encoded “key frame” is instead considered a B-mode encoded frame and not a key frame.

In the example of FIG. 3, video decoder 30 includes an entropy decoding unit 70, motion compensation unit 72, intra prediction unit 74, inverse quantization unit 76, inverse transformation unit 78, reference frame store 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70.

Motion compensation unit 72 may use motion vectors received in the bitstream to identify a prediction block in reference frames in reference frame store 82. Intra prediction unit 74 may use intra prediction modes received in the bitstream to form a prediction block from spatially adjacent blocks. Inverse quantization unit 76 inverse quantizes, i.e., de-quantizes, the quantized block coefficients provided in the bitstream and decoded by entropy decoding unit 70. The inverse quantization process may include a conventional process, e.g., as defined by the H.264 decoding standard. The inverse quantization process may also include use of a quantization parameter QP_{Y} calculated by encoder 50 for each macroblock to determine a degree of quantization and, likewise, a degree of inverse quantization that should be applied.

Inverse transform unit 58 applies an inverse transform, e.g., an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters. Identifiers for interpolation filters to be used for motion estimation with sub-pixel precision may be included in the syntax elements. Motion compensation unit 72 may use interpolation filters as used by video encoder 20 during encoding of the video block to calculate interpolated values for sub-integer pixels of a reference block. Motion compensation unit 72 may determine the interpolation filters used by video encoder 20 according to received syntax information and use the interpolation filters to produce predictive blocks.

Motion compensation unit 72 uses some of the syntax information to determine sizes of macroblocks used to encode frame(s) of the encoded video sequence, partition information that describes how each macroblock of a frame of the encoded video sequence is partitioned, modes indicating how each partition is encoded, one or more reference frames (or lists) for each inter-encoded macroblock or partition, and other information to decode the encoded video sequence.

Summer 80 sums the residual blocks with the corresponding prediction blocks generated by motion compensation unit 72 or intra-prediction unit to form decoded blocks. If desired, a deblocking filter may also be applied to filter the decoded blocks in order to remove blockiness artifacts. The decoded video blocks are then stored in reference frame store 82, which provides reference blocks for subsequent motion compensation and also produces decoded video for presentation on a display device (such as display device 32 of FIG. 1).

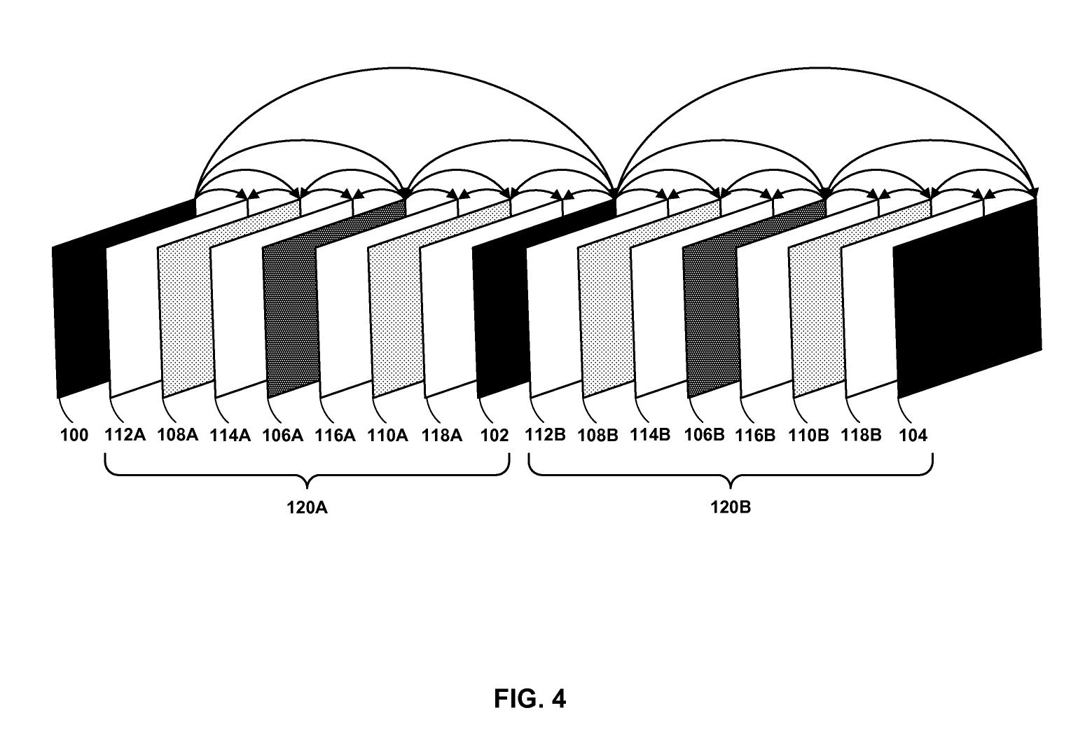

FIG. 4 is a conceptual diagram illustrating two example groups of pictures (GOPs) 120A, 120B, and corresponding key frames 102, 104 thereof. Frame 100 is also considered a key frame for a GOP occurring before GOP 120A. Each of GOPs 120A, 120B include eight frames in the example of FIG. 4. GOP 120A includes key frame 102 and frames 112A, 108A, 114A, 106A, 116A, 110A, and 118A. GOP 120B includes key frame 104 and frames 112B, 108B, 114B, 106B, 116B, 110B, and 118B. FIG. 4 generally represents a typical hierarchical prediction structure with 4 dyadic temporal stages. Key frames, such as key frames 100, 102, 104, generally build a self-contained subset of a sequence of frames in the sense that for coding of a key frame, only other (preceding) key pictures may be used as reference for motion compensated prediction. Non-key pictures of example GOPs 120A, 120B are coded as B pictures, as illustrated in FIG. 4, and use a hierarchical prediction structure.

More precisely, for coding of a picture denoted as Bₙ, only other pictures Bₘ of the same GOP (with n>m) or the two enclosing key pictures of the GOP may be used as reference. Thus, the decisions made when coding a picture Bₘ can only have an impact on pictures Bₙ, of the same GOP (with n>m). Since the lower the value of m, the more pictures are potentially influenced by this picture Bₘ, typically a cascading of quantization parameters (QPs) is used such that for pictures at the top of the hierarchical prediction structure (e.g., key frames 100, 102, 140), a smaller quantization step size is used than for those at the bottom (e.g., key frames 112, 114, 116, 118).

In the example of FIG. 4, key frame 102 is originally designated for inter-mode coding, with reference to key frame 100, as indicated by the arrow from key frame 100 to key frame 102. In general, an arrow from a first frame to a second frame indicates that the second frame is predicted with reference to the first frame. Two arrows to a first frame from two other frames indicate that the first frame is encoded in a B-mode with reference to the two other frames from which the arrows originate. Thus, for example, frame 106A is encoded using a B-encoding mode with reference to key frame 100 and key frame 104.

In accordance with the techniques of this disclosure, a video encoder, such as video encoder 20, may receive GOPs 120A, 120B and determine whether to B-encode key frame 102. That is, video encoder 20 may determine whether to bi-directionally predictive-encode key frame 102 with reference to key frames 100, 104. When video encoder 20 elects to B-encode key frame 102, key frame 102 is no longer considered a key frame, but is instead treated as another B-frame of a merged GOP comprising the frames of both GOPs 120A, 120B. The B-frame corresponding to frame 102 is bi-directionally inter-predictive encoded using key frame 100 and key frame 104 as reference frames. In this manner, when video encoder 20 determines to B-encode key frame 102, video encoder 20 adaptively forms a merged GOP comprising frames 112A, 108A, 114A, 106A, 116A, 110A, 118A, 102, 112B, 108B, 114B, 106B, 116B, 110B, 118B, and key frame 104. The decision scheme as to whether a key frame will be converted to a B-frame or not may be applied before encoding of the key frame. Accordingly, the scheme can be a part of preprocessing and/or encoder itself. The decision may be made based on a previous key picture and a next key picture in display order. Such a scheme may help to improve the coding efficiency of the encoder, without any change in the decoder syntax or semantics.

As described in greater detail below, to determine whether to B-encode key frame 102, video encoder 20 generally constructs a virtual key frame by interpolating pixel data from key frame 100 and key frame 104. In this manner, the virtual key frame may be considered an interpolated frame generated with respect to two reference frames, namely, frames 100 and 104. In some examples, video encoder 20 weights the contribution from each of frames 100 and 104 to the virtual frame equally. In other examples, video encoder 20 calculates a weight value corresponding to a percentage contribution from each of key frame 100 and key frame 104. For example, for a weight value w, w may comprise a rational number between 0 and 1 corresponding to a percent contribution from key frame 100 to creation of the virtual key frame, and the value (1−w) may comprise a supplementary percent contribution, also referred to as a supplementary weighting value, from key frame 104 to creation of the virtual key frame.

In one example, video encoder 20 calculates the following formula to calculate w. In the formula below, the function P(x, i, j) refers to the value of the pixel in key frame x at row i and column j. A value for x of 0 indicates a reference to the current key frame, a value for x of −1 indicates the previous key frame relative to the current key frame, and a value for x of 1 indicates the next key frame relative to the current key frame. With respect to the example of FIG. 4, a value of 0 for x refers to key frame 102, a value of −1 for x refers to key frame 100, and a value of 1 for x refers to key frame 104.

$$w = \frac{{\sum }_{i} {\sum }_{j} ( ( P ( 0 , i , j ) - P ( 1 , i , j ) ) * ( P {(}^{-} 1 , i , j ) - P ( 1 , i , j ) ) )}{{\sum }_{i} {\sum }_{j} ( {( P {(}^{-} 1 , i , j ) - P ( 1 , i , j ) )}^{2} )}$$

The formula for w above is derived according to the following. Let e comprise an error value that represents the error between the current key frame P₀ and the virtual key frame Pᵥ. Let P₋₁ refer to the previous key frame and P₁ refer to the next key frame, each relative to the current key frame P₀. Because e is an error value, that is, a difference value, and the goal is to obtain a weighting value w,

$$\begin{matrix}e = {P}_{0} - {P}_{v} \\ = {P}_{0} - ( w * {P}_{- 1} + ( 1 - w ) * {P}_{1} ) \\ = {P}_{0} - w * {P}_{- 1} + w * {P}_{1} - {P}_{1} \\ = ( {P}_{0} - {P}_{1} ) - w * ( {P}_{1} - {P}_{1} ) \end{matrix}$$

Using a squared error value, that is, e², the error is minimized according to

$$0 = \frac{\partial ( {e}^{2} )}{\partial w} ,$$

which results in the formula for w stated above.

After determining a weighting value w according to the formula above, video encoder 20 may generate a virtual key frame from the previous key frame 100 and next key frame 104. Video encoder 20 iterates over each pixel in the virtual key frame and assigns a value to the pixel of the virtual key frame corresponding to a weighted value from a collocated pixel in the previous key frame and a supplementary weighted value from a collocated pixel in the next key frame. That is, for each pixel in Pᵥ, where Pᵥ(i, refers to the pixel in row i and column j of virtual key frame Pᵥ, video encoder 20 assigns a value to Pᵥ(i,j) according to the formula w*P₀(i,j)+(1−w)*P₁(i,j). In this manner, video encoder 20 may construct a virtual key frame for the current key frame based on the pixel values in the previous and next key frames. Video encoder 20 may use the virtual key frame to determine whether to B-encode a key frame that would otherwise be P-encoded, as described in greater detail below.

Video encoder 20 may include a computer-readable storage medium encoded with instructions to perform a function similar to that of the following pseudocode. Alternatively, an ASIC, FPGA, DSP, or other hardware unit may be hard-coded to perform the method of the following pseudocode. Likewise, video encoder 20 may receive instructions via a transient computer-readable medium, e.g., a signal, to perform a method similar to the following pseudocode. In any case, the following pseudocode is an example method by which to calculate a virtual key frame according to the formulas described above:

frame generateVirtualKeyFrame (frame prevFrame, frame nextFrame,

frame currentFrame, int maxRow, int maxColumn) {
// generate weight value w
float wNum = 0, wDenom = 0, w = 0;
for (int i = 0; i < maxRow ; i++) {

for (int j = 0; j < maxColumn; j++) {

float diffVal = (prevFrame[i][j] − nextFrame[i][j]);
wNum = wNum + ((currentFrame[i][j] − nextFrame[i][j])
* diffVal); wDenom = wDenom + (diffVal * diffVal);

}

}
w = wNum / wDenom;
// generate virtual frame
frame virtualFrame[maxRow][maxColumn]; // constructs a new
frame with

// maxRow rows and maxColumn columns

for (int i = 0; i < maxRow ; i++) {

for (int j = 0; j < maxColumn; j++) {

virtualFrame[i][j] = w*prevFrame[i][j] +
(1−w)*nextFrame[i][j];

}

}
return virtualFrame;

}

The function “generateVirtualKeyFrame” produces a virtual key frame by interpolating the virtual key frame from two surrounding key frames, “prevFrame” and “nextFrame.” The function also receives the current key frame “currentFrame” and uses the current key frame, the next key frame, and the previous key frame to produce a weighting value “w.” Using the value of w, which indicates a percentage of each pixel value of the previous key frame to apply to the interpolation of a collocated pixel in the produced virtual frame, and the value (1−w), which indicates a percentage of each pixel value of the next key frame to apply to the interpolation of the collocated pixel in the produced virtual frame, the function generates the value of the collocated pixel in the virtual frame. After producing each pixel value in the virtual frame, the function returns the produced virtual frame “virtualFrame.”

Table 1 below illustrates the relationship between display order and coding order for each frame in the example of FIG. 4. In general, when a key frame (e.g., key frame 102) that is to be encoded as a P-frame is instead encoded as a B-frame, the GOP to which the key frame belongs and the following GOP, e.g., GOP 120A and GOP 120B, respectively, are effectively merged to form a single GOP. That is, the resulting GOP comprises each frame of GOP 120A and GOP 120B, and the “current” key frame is encoded as a B-frame rather than a P-frame or an I-frame. The merger occurs by indicating what frames belong to the merged GOP, e.g., in a header of the GOP. Accordingly, video encoder 20 may change the encoding order of frames of the merged GOP, as shown in Table 1. In general, the key frame of the second GOP (key frame 104 in this example) is encoded first in the merged GOP, whereas in the case in which the two GOPs are not merged, key frame 104 is encoded after all other frames of GOP 120A. Similarly, when GOP 120A and 120B are merged, each frame of GOP 120A is encoded one frame later relative to the unmerged GOPs 120A, 120B. Even after the merger, the encoding order of frames of GOP 120B in the merged GOP remains the same, other than the encoding order of the key frame of GOP 120B.

TABLE 1

| | | Encoding Order | Encoding Order |
|---|---|---|---|
| Frame Index | Display Order | (P-encoding) | (B-encoding) |
| 100 | 0 | 0 | 0 |
| 112A | 1 | 4 | 5 |
| 108A | 2 | 3 | 4 |
| 114A | 3 | 5 | 6 |
| 106A | 4 | 2 | 3 |
| 116A | 5 | 7 | 8 |
| 110A | 6 | 6 | 7 |
| 118A | 7 | 8 | 9 |
| 102 | 8 | 1 | 2 |
| 112B | 9 | 12 | 12 |
| 108B | 10 | 11 | 11 |
| 114B | 11 | 13 | 13 |
| 106B | 12 | 10 | 10 |
| 116B | 13 | 15 | 15 |
| 110B | 14 | 14 | 14 |
| 118B | 15 | 16 | 16 |
| 104 | 16 | 9 | 1 |

FIG. 5 is a flowchart illustrating an example method for determining whether to B-mode inter-prediction encode a key frame that is otherwise designated for P-mode inter-prediction encoding. Although primarily described with respect to video encoder 20, it should be understood that the method of FIG. 5 may be performed by a video preprocessing unit, a video CODEC comprising both a video encoder and a video decoder, or other video processing unit.

Initially, video encoder 20 receives a current group of pictures (GOP) comprising a key frame (130). It is assumed that the current GOP is received after a previous GOP, for which a decoded “previous” key frame resides in reference frame store 84. Video encoder 20 may also receive a next GOP that occurs after the current GOP, where the next GOP comprises a “next” key frame.

Using the previous key frame and the next key frame relative to the current key frame of the current GOP, video encoder 20 calculates a weighting value w to determine a percent contribution from each of the previous key frame and the next key frame (132). In one example, video encoder 20 uses the formula described above with respect to FIG. 4 to calculate the weighting value. That is, in one example, video encoder 20 calculates (as described above with respect to FIG. 4):

$$w = \frac{{\sum }_{i} {\sum }_{j} ( ( P ( 0 , i , j ) - P ( 1 , i , j ) ) * ( P {(}^{-} 1 , i , j ) - P ( 1 , i , j ) ) )}{{\sum }_{i} {\sum }_{j} ( {( P {(}^{-} 1 , i , j ) - P ( 1 , i , j ) )}^{2} )}$$

Applying this value of w to each pixel of the previous key frame, and the supplement of the value of w (that is, “1−w”) to each pixel of the next key frame, video encoder 20 generates a virtual key frame (134). That is, for each pixel Pᵥ[i][j] in virtual frame Pᵥ, video encoder 20 calculates the value of the pixel as w*P₋₁[i][j]+(1−w)*P₁[i][j], where P₋₁ refers to the previous key frame and P₁ refers to the next key frame, and where i and j are indexes to the row and column of the pixel. In this manner, video encoder 20 may generate the virtual key frame from weighted values of the previous key frame and the next key frame.

After generating the virtual key frame, video encoder 20 calculates an error value, referred to herein as E, which corresponds to the error between the current key frame and the virtual key frame (136). Video encoder 20 may calculate E using SAD, SSD, MAD, MSD, or any other error calculation metric. For example, video encoder 20 may be configured to accumulate the errors between each collocated pixel of the virtual key frame and the current key frame as the SAD error value for E.

Video encoder 20 may then calculate error values between the current key frame and the previous key frame (referred to as E_{A}) (138) and between the current key frame and the next key frame (referred to as E_{B}) (140). Again, video encoder 20 may use any error calculation method to calculate values for E_{A} and E_{B}, although generally video encoder 20 uses the same error calculation method as that used to calculate E above. For example, when video encoder 20 calculates E using SAD, video encoder 20 may also calculate E_{A} and E_{B} using SAD.

Next, video encoder 20 compares the error value E to the minimum of E_{A} and E_{B} to determine whether E is less than the minimum of E_{A} and E_{B} (142). That is, video encoder 20 determines whether the error value between the current key frame and the virtual key frame is less than the minimum of the error value between the current key frame and the previous key frame and the error value between the current key frame and the next key frame. In effect, the result of this comparison is the same as if video encoder 20 determines whether E is less than both E_{A} and E_{B}, because if E is less than the minimum of E_{A} and E_{B}, E is necessarily less than the minimum of E_{A} and E_{B}. Either or both of E_{A} and/or E_{B} may therefore be considered threshold values, in that video encoder 20 compares the value of E to E_{A} and E_{B}.

In some examples, video encoder 20 may multiply E by a bias value before the comparison, to influence video encoder 20 either in favor of or against encoding the current key frame as a B-frame. The result of the multiplication of the error value and the bias value may be referred to as a biased error value. The bias value is generally configurable, e.g., by an administrator or other user. When the bias value is between 0 and 1, video encoder 20 will be more likely to encode the key frame as a B-frame, whereas when the bias value is greater than 1, video encoder 20 will be less likely to encode they key frame as a B-frame.

When video encoder 20 determines that E, as adjusted by the bias value (if any), is less than the minimum of E_{A} and E_{B} (“YES” branch of 142), video encoder 20 elects to encode the key frame as a B-frame (144). In general, the difference between the virtual key frame (generated using the estimation technique described above) and the current key frame being relatively small indicates that a frame generated with reference to the previous key frame and the next key frame using motion estimation and motion compensation will likely have even less error, and therefore, that encoding the key frame as a B-frame will likely be beneficial in terms of bit savings, reduction of bandwidth, and quality improvement. As examples, when the key frame occurs in a scene change, a cross-fade, or as part of video morphing, encoding the key frame as a B-frame will likely result in reduced error.

However, when video encoder 20 determines that E, as adjusted by the bias value, is not less than the minimum of E_{A} and E_{B}, (“NO” branch of 142), video encoder 20 instead encodes the current key picture using the originally selected encoding mode (146). Typically, the originally selected encoding mode comprises P-mode inter-encoding, although in some examples, the originally selected mode may comprise intra-encoding.

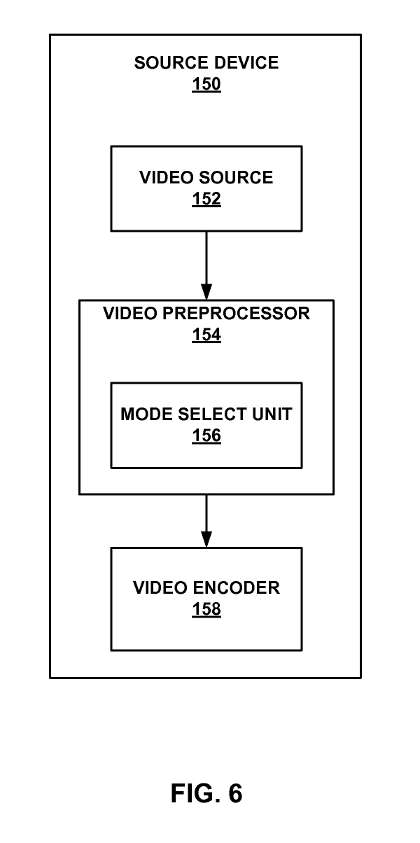

FIG. 6 is a block diagram illustrating an example video source 150 comprising a video source device 152 that includes video preprocessor 154 comprising mode select unit 156. In general, video source device 152 is substantially similar to video source device 12 of FIG. 1, except that in the example of FIG. 6, video source device 152 comprises video preprocessor 154, which comprises mode select unit 156. Mode select unit 156 of video preprocessor 154 may be configured to perform the techniques of this disclosure, e.g., determining whether to B-encode a key frame of a GOP. For example, mode select unit 156 may be configured to perform the method of FIG. 5. When mode select unit 156 determines that a key frame of a GOP should be B-encoded, mode select unit 156 may send an indication that the key frame should be B-encoded to video encoder 158. The indication may include an identifier of the current GOP, an identifier of a next GOP (with which to merge the current GOP), an identifier of the key frame to be B-encoded, and/or hierarchical coding information, that is, a description of the hierarchical coding order of frames of the current frame and the next frame.

Video encoder 158 may be configured similarly to video encoder 20 (FIGS. 1 and 2). However, video encoder 158 may differ from video encoder 20 in that video encoder 158 itself need not be configured to determine whether to B-encode a key frame of a GOP to effect the techniques of this disclosure. Instead, video encoder 158 may be configured to receive the indication from video preprocessor 154, e.g., the identifier of the current GOP, the identifier of the next GOP, the identifier of the key frame to be B-encoded, and the hierarchical coding information. Alternatively, video encoder 158 may be configured to determine the hierarchical coding order of frames of the current GOP and the next GOP. When video encoder 158 receives an indication that a key frame should be B-encoded from video preprocessor 154, video encoder 158 may B-encode the key frame and merge the current GOP and next GOP, as described above. Video encoder 158 may additionally be configured to perform a check as to whether an I-frame has occurred recently enough as prescribed by a relevant video encoding standard and, if there has not been an I-frame recently enough, to override the indication from video preprocessor 154 and instead encode the key frame as an I-frame. Likewise, if video preprocessor 154 does not indicate that the key frame should be B-encoded, video encoder 158 may instead I-encode or P-encode the key frame. Although video encoder 158 need not necessarily be configured to perform the decision as to whether to B-encode a key frame of a GOP, video encoder 158 may still comprise a mode select unit configured to perform mode selection with respect to other frames, e.g., whether to encode non-key frames as I-frames, P-frames, or B-frames, and to determine whether to override an indication from video preprocessor 154.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. One embodiment includes a computer program product that includes a non-transitory computer readable storage medium having executable instructions stored thereon for performing one or more of the methods disclosed herein.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of encoding a video signal, the method comprising:
generating a virtual key frame for a current group of pictures based on a previous key frame of a previous group of pictures and a next key frame of a next group of pictures;
calculating an error value representing error between a current key frame of the current group of pictures and the virtual key frame;
determining whether the error value exceeds a threshold value; and
when the error value does not exceed the threshold value, encoding the current key frame using a bi-directional prediction encoding mode.

2. The method of claim 1, further comprising, when the error value meets or exceeds the threshold value, encoding, with the video encoder, the current key frame using a uni-directional prediction encoding mode.

3. The method of claim 1, wherein generating the virtual key frame comprises calculating a first weighting value to apply to the previous key frame and a second weighting value to apply to the next key frame.

4. The method of claim 3, wherein the first weighting value represents a percentage of each pixel of the previous key frame to apply to a collocated pixel of the virtual key frame, and wherein the second weighting value comprises one minus the first weighting value.

5. The method of claim 3, wherein generating the virtual key frame comprises setting a value for a pixel of the virtual key frame equal to the first weighting value multiplied by a collocated pixel value of the previous key frame plus the second weighting value multiplied by a collocated pixel value of the next key frame.

6. The method of claim 1, wherein calculating the error value comprises calculating at least one of a sum of absolute difference, sum squared difference, mean absolute difference, and mean squared difference between pixel values of the current key frame and the virtual key frame.

7. The method of claim 1, wherein determining whether the error value exceeds a threshold value comprises:
calculating a second error value representing error between the current key frame and the previous key frame;
calculating a third error value representing error between the current key frame and the next key frame; and
determining whether the error value representing error between a current key frame of the current group of pictures and the virtual key frame is lower than the second error value and the third error value.

8. The method of claim 1, wherein determining whether the error value is lower than the threshold comprises applying a bias value to the error value to produce a biased error value and determining whether the biased error value is less than the threshold.

9. The method of claim 1, wherein encoding the key frame using a bi-directional prediction encoding mode comprises using the previous key frame as a first reference frame and using the next key frame as a second reference frame for encoding the current key frame as a B-frame.

10. The method of claim 1, further comprising producing a merged group of pictures comprising encoded versions of each frame of the current group of pictures including the encoded current key frame, comprising a B-frame, and encoded versions of each frame of the next group of pictures including an encoded version of the next key frame.

11. The method of claim 10, wherein producing the merged group of pictures comprises modifying an encoding order of the frames of the current group of pictures and the frames of the next group of pictures such that the next key frame of the next group of pictures is encoded before all frames of the current group of pictures.

12. An apparatus for encoding video signals, the apparatus comprising:
a mode select unit configured to generate a virtual key frame for a current group of pictures based on a previous key frame of a previous group of pictures and a next key frame of a next group of pictures, calculate an error value representing error between a current key frame of the current group of pictures and the virtual key frame, and determine whether the error value exceeds a threshold value; and
a video encoder configured to encode the current key frame using a bi-directional prediction encoding mode when the error value does not exceed the threshold value.

13. The apparatus of claim 12, wherein the video encoder is further configured to encode the current key frame using a uni-directional prediction encoding mode when the error value meets or exceeds the threshold value.

14. The apparatus of claim 12, wherein the video encoder comprises the mode select unit.

15. The apparatus of claim 12, further comprising a video preprocessing unit, wherein the video preprocessing unit comprises the mode select unit.

16. The apparatus of claim 12, wherein to generate the virtual key frame, the mode select unit is configured to calculate a first weighting value to apply to the previous key frame and a second weighting value to apply to the next key frame.

17. The apparatus of claim 16, wherein the first weighting value represents a percentage of each pixel of the previous key frame to apply to a collocated pixel of the virtual key frame, and wherein the second weighting value comprises one minus the first weighting value.

18. The apparatus of claim 16, wherein to generate the virtual key frame, the mode select unit is further configured to set a value for a pixel of the virtual key frame equal to the first weighting value multiplied by a collocated pixel of the previous key frame plus the second weighting value multiplied by a collocated pixel of the next key frame.

19. The apparatus of claim 12, wherein to calculate the error value, the mode select unit is configured to calculate at least one of a sum of absolute difference, sum squared difference, mean absolute difference, and mean squared difference between the current key frame and the virtual key frame.

20. The apparatus of claim 12, wherein the error value comprises a first error value, and wherein to determine whether the error value exceeds a threshold value, the mode select unit is configured to calculate a second error value representing error between the current key frame and the previous key frame, calculate a third error value representing error between the current key frame and the next key frame, and determine whether the first error value is lower than both the second error value and the third error value.

21. The apparatus of claim 12, wherein to determine whether the error value is lower than the threshold, the mode select unit is configured to apply a bias value to the error value to produce a biased error value and to determine whether the biased error value is less than the threshold.

22. The apparatus of claim 12, wherein to encode the key frame using a bi-directional prediction encoding mode, the video encoder is configured to use the previous key frame as a first reference frame and to use the next key frame as a second reference frame for encoding the current key frame as a B-frame.

23. The apparatus of claim 12, wherein the video encoder is configured to produce a merged group of pictures comprising encoded versions of each frame of the current group of pictures including the encoded current key frame, comprising a B-frame, and encoded versions of each frame of the next group of pictures including an encoded version of the next key frame.

24. The apparatus of claim 23, wherein to produce the merged group of pictures, the video encoder is configured to modify an encoding order of the frames of the current group of pictures and the frames of the next group of pictures such that the next key frame of the next group of pictures is encoded before all frames of the current group of pictures.

25. The apparatus of claim 12, wherein the apparatus comprises at least one of:
an integrated circuit;
a microprocessor; and
a wireless communication device that includes the video encoder.

26. An apparatus for encoding video signals, the apparatus comprising:
means for generating a virtual key frame for a current group of pictures based on a previous key frame of a previous group of pictures and a next key frame of a next group of pictures;
means for calculating an error value representing error between a current key frame of the current group of pictures and the virtual key frame;
means for determining whether the error value exceeds a threshold value; and
means for encoding the current key frame using a bi-directional prediction encoding mode when the error value does not exceed the threshold value.

27. The apparatus of claim 26, further comprising means for encoding the current key frame using a uni-directional prediction encoding mode when the error value meets or exceeds the threshold value.

28. The apparatus of claim 26, wherein the means for generating the virtual key frame comprise means for calculating a first weighting value to apply to the previous key frame and a second weighting value to apply to the next key frame.

29. The apparatus of claim 28, wherein the first weighting value represents a percentage of the previous key frame to apply to the virtual key frame, and wherein the second weighting value comprises one minus the first weighting value.

30. The apparatus of claim 28, wherein the means for generating the virtual key frame comprises means for setting a value for a pixel of the virtual key frame equal to the first weighting value multiplied by a collocated pixel of the previous key frame plus the second weighting value multiplied by a collocated pixel of the next key frame.

31. The apparatus of claim 26, wherein the means for calculating the error value comprises means for calculating at least one of a sum of absolute difference, sum squared difference, mean absolute difference, and mean squared difference between the current key frame and the virtual key frame.

32. The apparatus of claim 26, wherein the error value comprises a first error value, and wherein the means for determining whether the error value exceeds a threshold value comprises:
means for calculating a second error value representing error between the current key frame and the previous key frame;
means for calculating a third error value representing error between the current key frame and the next key frame; and
means for determining whether the first error value is lower than the second error value and the third error value.

33. The apparatus of claim 26, wherein the means for determining whether the error value is lower than the threshold comprises means for applying a bias value to the error value to produce a biased error value and means for determining whether the biased error value is less than the threshold.

34. The apparatus of claim 26, wherein the means for encoding the key frame using a bi-directional prediction encoding mode comprises means for using the previous key frame as a first reference frame and means for using the next key frame as a second reference frame for encoding the current key frame as a B-frame.

35. The apparatus of claim 26, further comprising means for producing a merged group of pictures comprising encoded versions of each frame of the current group of pictures including the encoded current key frame, comprising a B-frame, and encoded versions of each frame of the next group of pictures including an encoded version of the next key frame.

36. The apparatus of claim 35, wherein the means for producing the merged group of pictures comprises means for modifying an encoding order of the frames of the current group of pictures and the frames of the next group of pictures such that the next key frame of the next group of pictures is encoded before all frames of the current group of pictures.

37. A computer program product for use with a video encoder having a programmable processor, comprising:
a computer-readable storage medium having stored thereon encoded executable instructions that when executed cause a programmable processor to:
generate a virtual key frame, in place of a current key frame of a current group of pictures, from a previous key frame of a previous group of pictures and a next key frame of a next group of pictures;
calculate an error value representing error between the current key frame and the virtual key frame;
determine whether the error value exceeds a threshold value; and
encode the current key frame using a bi-directional prediction encoding mode when the error value does not exceed the threshold value.

38. The computer program product of claim 37, the medium having stored thereon instructions to encode the current key frame using a uni-directional prediction encoding mode when the error value meets or exceeds the threshold value.

39. The computer program product of claim 37, wherein the instructions to generate the virtual key frame comprise instructions to calculate a first weighting value to apply to the previous key frame and a second weighting value to apply to the next key frame.

40. The computer program product of claim 39, wherein the first weighting value represents a percentage of the previous key frame to apply to the virtual key frame, and wherein the second weighting value comprises one minus the first weighting value.

41. The computer program product of claim 39, wherein the instructions to generate the virtual key frame comprise instructions to set a value for a pixel of the virtual key frame equal to the first weighting value multiplied by a collocated pixel of the previous key frame plus the second weighting value multiplied by a collocated pixel of the next key frame.

42. The computer program product of claim 37, wherein the instructions to calculate the error value comprise instructions to calculate at least one of a sum of absolute difference, sum squared difference, mean absolute difference, and mean squared difference between the current key frame and the virtual key frame.

43. The computer program product of claim 37, wherein the error value comprises a first error value, and wherein the instructions to determine whether the error value exceeds a threshold value comprise instructions to:
calculate a second error value representing error between the current key frame and the previous key frame;
calculate a third error value representing error between the current key frame and the next key frame; and
determine whether the first error value is lower than the second error value and the third error value.

44. The computer program product of claim 37, wherein the instructions to determine whether the error value is lower than the threshold comprise instructions to apply a bias value to the error value to produce a biased error value and instructions to determine whether the biased error value is less than the threshold.

45. The computer program product of claim 37, wherein the instructions to encode the key frame using a bi-directional prediction encoding mode comprise instructions to use the previous key frame as a first reference frame and instructions to use the next key frame as a second reference frame for encoding the current key frame as a B-frame.

46. The computer program product of claim 37, wherein the medium further has stored thereon instructions to produce a merged group of pictures comprising encoded versions of each frame of the current group of pictures including the encoded current key frame, comprising a B-frame, and encoded versions of each frame of the next group of pictures including an encoded version of the next key frame.

47. The computer program product of claim 46, wherein the instructions to produce the merged group of pictures comprise instructions to modify an encoding order of the frames of the current group of pictures and the frames of the next group of pictures such that the next key frame of the next group of pictures is encoded before all frames of the current group of pictures.
